(19) United States
(12) Patent Application Publication
(10) Pub. No.: US 2004/0082367 A1
(43) Pub. Date: Apr. 29, 2004

(54) Electronic apparatus

(76) Inventors: Kiyoshi Nakanishi, Kanagawa (JP); Hazuki Yokose, Kanagawa (JP)

Correspondence Address: PEARNE & GORDON LLP, 1801 EAST 9TH STREET, SUITE 1200, CLEVELAND, OH, 44114-3108, US

(21) Appl. No.: 10/466,739

(22) PCT Filed: Jun. 6, 2002
(86) PCT No.: PCT/JP02/05620

(30) Foreign Application Priority Data
Jun. 15, 2001 (JP) 2001-181813

(51) Int. Cl. H04M 1/00; H04B 1/38

(52) U.S. Cl. 455/566; 455/550.1

(57) ABSTRACT

The invention aims at providing electronic apparatus having a mirror which functions in an arbitrary operating state and electronic apparatus which attains low power consumption while serving as a mirror. A light reflective panel(12) whose reflectivity change with the value of a voltage applied is arranged on an LCD(30) of the display (10) of the electronic apparatus; the reflectivity of the light reflective panel(12) is increased and the panel is used as a mirror in a predetermined state where an LCD(30) is not used, such like a portable cell phone(100) performs a incoming call processing, while the reflectivity of the light reflective panel(12) is decreased to place the light reflective panel(12) in the transmittance state so that the LCD(30) may be used. It is thus possible to allow the display(10) provided with the light reflective panel(12) to function as a mirror.

### TECHNICAL FIELD

The present invention relates to an electronic apparatus having portability, such as a cell phone, a PHS (Personal Handy phone System (registered trademark)) and a PDA (Personal Digital Assistant).

### BACKGROUND OF THE INVENTION

Electronic apparatus such as a cell phone may be equipped with a mirror to meet the request or convenience of the user. As an example of this type of apparatus, a portable electronic apparatus equipped with a mirror is disclosed in the Japanese Patent Laid-Open No. 2000-196718. In this electronic apparatus, the front main body of a cell phone is a mirror section, part of which is composed of a half mirror. Behind the half mirror is provided display means (LCD: Liquid Crystal Display). While the backlight of the LCD is turned off, the entire mirror section including the half mirror serves as a mirror. While the backlight is turned on, a display on the LCD is visible through the half mirror. The Japanese Patent Laid-Open No. 2000-299719 discloses an electronic apparatus equipped with a half mirror in front of its LCD, same as the technology disclosed in the Japanese Patent Laid-Open No. 2000-196718.

However, in the electronic apparatus of the aforementioned related art electronic apparatus, the mirror serves as a mirror while the backlight of the LCD is turned off. Display on the LCD is recognized while the backlight is turned on. So it is necessary to turn on the LCD and the backlight in case it is not necessary to use the mirror. It is thus difficult to switch between the mirror and a display on the LCD in an arbitrary operating state. To provide a display on an LCD, the LCD and the backlight must be turned on. This increases power consumption and long-time use of the electronic apparatus is difficult in case a rechargeable battery or dry battery is used as a power source.

A combination of a half mirror and an LCD according to the related art may be arranged in limited locations only. It is thus impossible to use a desired location as a mirror in an arbitrary operating state.

### DISCLOSURE OF THE INVENTION

The present invention has been accomplished in view of the aforementioned circumstances and aims at providing an electronic apparatus having a mirror which functions in an arbitrary operating state. The invention also aims at providing an electronic apparatus which attains low power consumption while serving as a mirror.

Further, the invention aims at providing an electronic apparatus which allows a desired location to serve as a mirror. The invention also aims at providing an electronic apparatus which can switch a desired location to a mirror to change the apparatus design.

The invention provides an electronic apparatus comprising a light reflective device whose reflectivity varies with a voltage applied, the light reflective device provided on the whole or part of a section visible from outside the apparatus and control means for controlling the value of a voltage applied to the light reflective device in association with an operation or a function of the apparatus.

The electronic apparatus is characterized in that the light reflective device enters a transmittance state where a light is generally transmitted when a voltage is not applied and a mirror state where a light is generally reflected when a predetermined voltage is applied.

The electronic apparatus is characterized in that the control means controls the voltage applied to the light reflective device and sets the light reflective device to a mirror state where a light is generally reflected in a predetermined state in association with an operation or a function of the apparatus.

The electronic apparatus is characterized in that the control means controls the voltage applied to the light reflective device and sets the light reflective device to a transmittance state where a light is generally transmitted in a predetermined state in association with an operation or a function of the apparatus.

The electronic apparatus is characterized in that the apparatus comprises display means for providing a display concerning an operation or a function of the apparatus and that the light reflective device formed into the shape of a plate or a film and is provided on the display means.

The electronic apparatus is characterized in that the display means comprises an LCD and that the control means sets the light reflective device to the mirror state where a light is generally reflected in a predetermined state in association with an operation or a function of the apparatus and turns off the LCD concurrently.

The electronic apparatus is characterized in that the apparatus comprises image pickup means for shooting a subject and that the light reflective device is formed into the shape of a plate or a film and is provided in close proximity of the display means.

The electronic apparatus is characterized in that the apparatus comprises a light-emitting device inside the light reflective device and that the control means sets the light reflective device to the mirror state where a light is generally reflected in a shooting mode by the image pickup means and to the transmittance state where a light is generally transmitted when the light-emitting device is illuminated.

The electronic apparatus is characterized in that the light reflective device is formed into the shape of a plate or a film and is provided on at least part of an enclosure or external surface component of the apparatus.

According to this configuration, reflectivity of the light reflective device varies with an operation or a function of the electronic apparatus. For example, a light reflective device is arranged on an LCD on the display of the electronic apparatus; the reflectivity of the light reflective device is increased and the device is used as a mirror in a predetermined state where an LCD is not used, while the reflectivity of the light reflective device is decreased so that the display on the LCD may be visible when an LCD is used as a display. In this case, when the light reflective device is used as a mirror, the LCD inside and its backlight can be turned off, so that it is possible to reduce power consumption and increase the service life of the battery.

For example, image pickup means is provided on an electronic apparatus, a light reflective device is provided in close proximity of the image pickup means and a light-emitting device is provided inside the light reflective device. The light reflective device is set to the mirror state in the shooting mode by the image pickup means while the light reflective device is set to the transmittance state when the light reflective device is illuminated. In this case, a mirror may be provided to reflect the user himself/herself in photography shooting. The light-emitting device may be used as an indicator for status indication or used as a strobe light and caused to transmit a light to allow external light emission.

For example, the light reflective device is formed into the shape of a film and is provided on at least part of an enclosure or external surface component of the apparatus. In this case, it is possible to allow a desired location provided wit a light reflective device to serve as a mirror or vary the color design of the apparatus in association with an arbitrary operating state. By rotatably connecting two enclosures to form a collapsible shape and providing a light reflective device in the inner location when the enclosures are folded in order to provide the mirror state in association with opening/closing of the enclosures, it is possible to use an electronic apparatus such as a cell phone as a portable mirror. It is possible to provide a light reflective device on the upper surface of a key in the key operation section, antenna, receiver, microphone, speaker, battery pack, or touch panel so as to switch between the mirror state and the transmittance state in accordance with the state of a specific operation or function thus varying the apparatus design or easy recognition of the operating state by the user.

### BRIEF DESCRIPTION OF THE DRAWINGS

FIG. 1 is a block diagram showing the configuration of a cell phone according to a first embodiment of the invention;

FIG. 2 is a front view of the outer appearance of a cell phone according to the first embodiment of the invention;

FIGS. 3A and 3B are sectional explanatory views of the structure of a light reflective panel according to an embodiment of the invention;

FIG. 4 is a flowchart explaining the operation of a cell phone according to the first embodiment of the invention;

FIG. 5 shows an example where a light reflective panel is attached to a rod-type cell phone as a variation of attaching a light reflective panel on another section.

FIG. 6 shows an example where a light reflective panel is attached to a rod-type cell phone as a variation of attaching a light reflective panel on another section.

FIG. 7 shows an example where a light reflective panel is attached to a collapsible cell phone as a variation of attaching a light reflective panel on another section.

FIG. 8 shows an example where a light reflective panel is attached to a collapsible cell phone as a variation of attaching a light reflective panel on another section.

FIG. 9 is a block diagram showing the configuration of a cell phone according to a second embodiment of the invention;

FIGS. 10A and 10B are front views of the outer appearance of a cell phone according to the second embodiment of the invention;

FIG. 11 is sectional explanatory view of the structure of a light reflective panel and its periphery according to the second embodiment of the invention;

FIG. 12 is a flowchart explaining the operation of a cell phone according to the second embodiment of the invention.

In the figures, a numeral 1 represents an antenna, 2 a shared antenna section, 3 a transceiver, 4 a key operation section, 4n a key, 5 a camera sensor, 5A a lens, 6 a camera signal processor, 7 a speaker, 8 a receiver, 9 a microphone, 10 a display, 11 a display controller, 12 a light reflective panel, 13 a control signal generator, 14 a memory, 15 a central control, 20 a liquid crystal material, 21a and 21b transparent electrodes, 22 a polarizer, 23 a reflective polarizer, 30 an LCD, 31 a light guide plate, 42 a battery pack, 50 a light-emitting device, and 51 a substrate.

### BEST MODE FOR CARRYING OUT THE INVENTION

Embodiments of the invention will be described referring to drawings.

[First Embodiment]

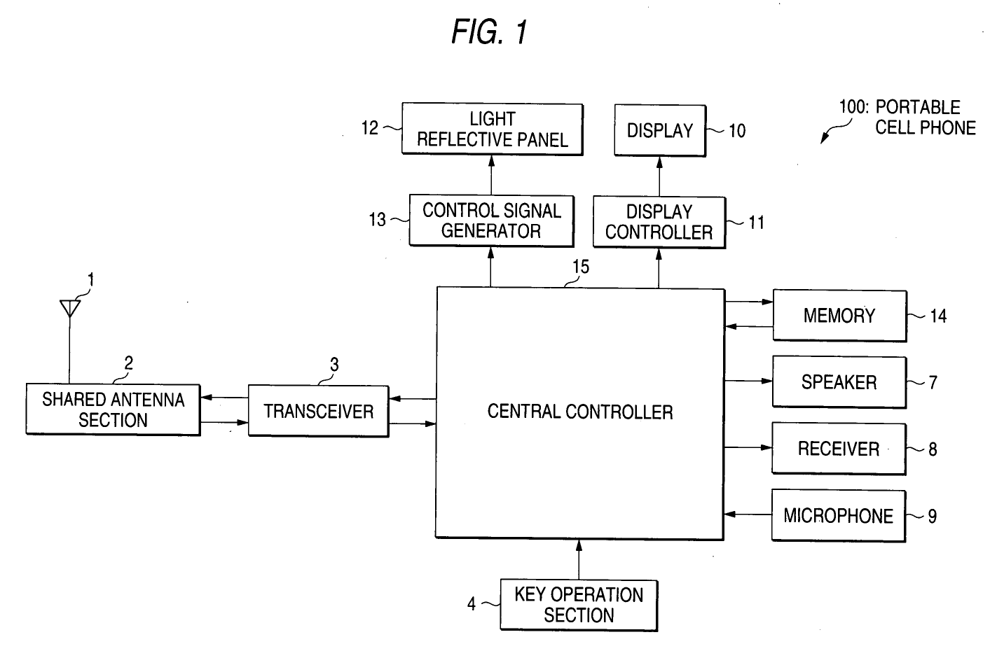

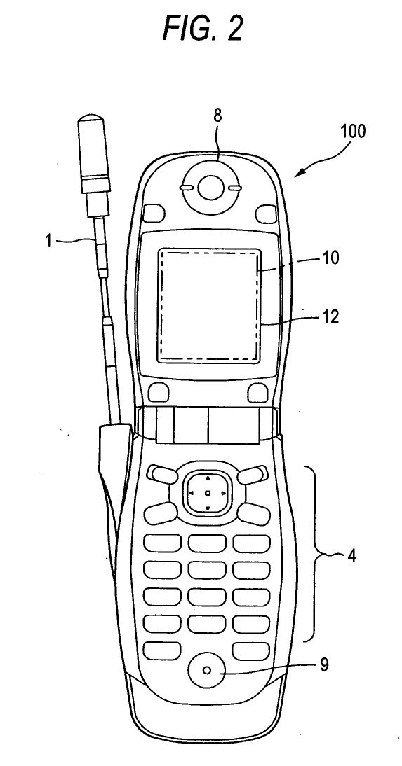

FIG. 1 is a block diagram showing the configuration of a cell phone according to the first embodiment of the invention. FIG. 2 is a front view of the outer appearance of a cell phone according to the first embodiment of the invention. This embodiment shows an example where the invention is applied to a portable terminal, especially a collapsible cell phone as an example of an electronic apparatus.

In FIG. 1, a portable cell phone 100 according to this embodiment comprises an antenna 1, a shared antenna section 2, a transceiver 3, a key operation section 4, a speaker 7, a receiver 8, a microphone 9, a display 10, a display controller 11, a light reflective panel (light reflective device) 12, a control signal generator 13, a memory 14, and a central control 15.

The shared antenna section 2 comprises a transmitting filter and a receiving filter (not shown) so as to allow simultaneous radio wave transmission/reception via a single antenna 1. The transceiver 3, comprising a radio communications circuit for transmission/reception, modulates transmit data by using a predetermined modulation system to generate a radio signal for transmission as well as demodulates a received radio signal to extract receive data. The key operation section 4 comprises a plurality of keys to operate the cell phone and arranged to generate and output a key code in response to operation of a key.

The speaker 7 is used to output a call incoming tone, the voice of a distant party, and a notice tone of the cell phone 100. The receiver 8 is used to output the voice of a distant party. The microphone 9 is used to input the voice of the user of the cell phone 100. The display 10 comprising a display device such as an LCD (Liquid Crystal Display) is used for various display applications related to operation of a cell phone, such as display of the directory number of a calling party or a called party, mail messages, a clock and a calendar, a telephone directory, and call origination/termination history. The display 10 is, as shown in FIG. 2, arranged approximately in the center of the front panel of the cell phone 100. The display controller 11 makes controls to provide display data input from the central control 15 on the display 10.

The light reflective panel 12 as a light reflective device changes its reflectivity in accordance with the magnitude of the value of a voltage applied. The light reflective panel 12 is formed into the shape of a plate or a film and is provided on the display 10. Details of the light reflective panel 12 will be given later. The control signal generator 13 applies for example a voltage of a binary value as a control signal to the light reflective panel 12 in accordance with a command input from the central control 15. That is, in case the light reflective panel 12 is used as a mirror, a voltage (on voltage) where a reflectivity of the light reflective panel available as a mirror is obtained or transmittance is the maximum is applied to the light reflective panel 12. In case the light reflective panel 12 is used as a transparent panel instead of a mirror, a voltage (off−voltage=approx. 0 V) where the reflectivity is approximately zero or transmittance is the minimum so as to assure a clear view of the display 10 is applied to the light reflective panel 12.

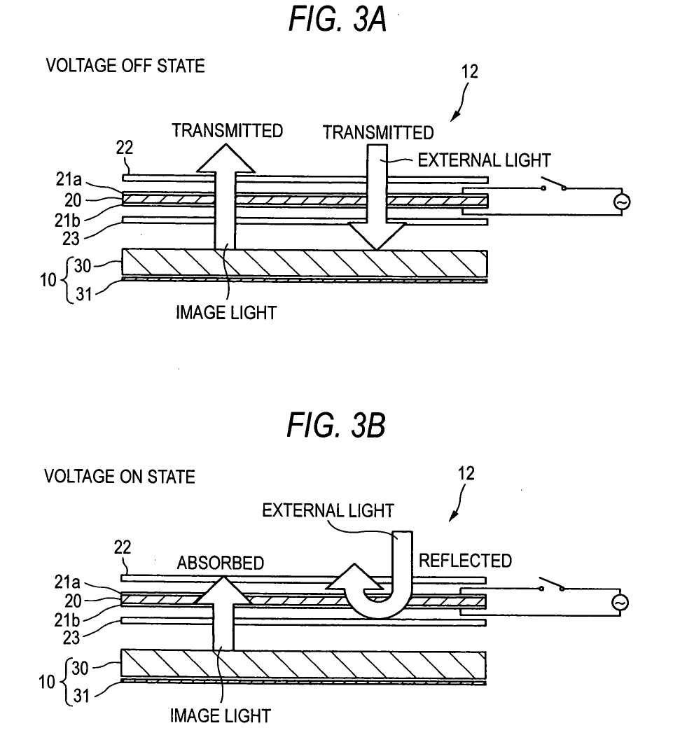

FIGS. 3A and 3B are explanatory views showing the structure of the light reflective panel 12. FIG. 3A shows the state of the light reflective panel 12 assumed in case the voltage is turned off. FIG. 3B shows the state of the light reflective panel 12 assumed in case the voltage is turned on. The light reflective panel 12 comprises a liquid crystal material 20, transparent electrodes 21a, 21b to apply a voltage to this liquid crystal material 20, a polarizer 22 arranged on the front surface (upper side in the figure) of the liquid crystal material 20, and a reflective polarizer 23 arranged on the rear surface (lower side in the figure) of the liquid crystal material 20. The light reflective panel 12 is arranged with its reflective polarizer 23 facing toward the display arranged inside the apparatus (lower side in the figure). On the bottom surface of the LCD 30 of the display 10 is arranged a light guide plate 31 for supplying a light from the light source of a backlight to the LCD 30.

The light reflective panel 12 changes the alignment of liquid crystal in accordance with the magnitude of a voltage applied to the liquid crystal material 20 and changes its opening in relation to the polarizer 22 and the reflective polarizer 23. When no voltage is applied (voltage off), the maximum opening is provided to generally transmit an external light and a light for displaying emitted from the display 30 (transmittance state). In this case, the display on the LCD 30 is normally visible. In case a voltage is applied sufficient to generally reflect a light (voltage on), the minimum opening is provided to absorb a light for displaying emitted from the display 30 and reflect an external light (mirror state). In this case, the light reflective panel 12 becomes a mirror-like surface and serves as a mirror. In the mirror state, power feeding to the LCD 30 of the display 10 and the backlight is halted to turn off the apparatus. The opening of the light reflective panel 12 is not reduced to zero so that it is possible to recognize the display on the LCD 30 by half-transmitting the display on the LCD 30 depending on the voltage applied to the light reflective panel or brightness of the LCD.

Referring to FIG. 1 again, the central control 15 controls each section of the apparatus in accordance with a program stored in the ROM (Read-only Memory) of the memory 14 while using the RAM (Random Access Memory) of the memory 14 as a working memory. In case the display 10 must be used, such as on termination of a call or a mail, the central control 15 places the light reflective panel 12 in the transmittance state. Otherwise the central control places the light reflective panel 12 in the mirror state. In this way, the central control 15 controls the light reflective panel 12 in association with the function or operation of the cell phone.

The following lists the cases where the central control 15 sets the light reflective panel 12 to the mirror state or transmittance state:

(1) Normal Standby Mode

<1 >When a predetermined time has elapsed with no key entry detected after key operation on the key operation section 4 is terminated, the light reflective panel 12 is set to the mirror state.

<2>When the user watches the display 100 or the user may be engaged in a call with the collapsible cell phone 100 unfolded (hereinafter referred to as the open state), the light reflective panel 12 is set to the transmittance state.

<3>When the cell phone 100 in the folded state (hereinafter referred to as the closed state) is unfolded (open state), the light reflective panel 12 is set to the mirror state.

(2) Alarm Operation

<1>When a preset alarm time is reached, the light reflective panel 12 is set to the mirror state with a sound or vibration.

<2>On termination of a call, mail or various services in the mirror state, the light reflective panel 12 is set to the transmittance state.

(3) During Call Origination

While the user is operating keys on the key operation section 4, the light reflective panel 12 is set to the transmittance state.

(4) During/After Call Termination (In Case the Call is not Answered)

<1>The light reflective panel 12 is set to the transmittance state on call termination.

<2>When the cell phone shifts from the closed state to the open state after call termination, the light reflective panel 12 is set to the transmittance state.

<3>In case the directory number of the caller is a non-display registration number registered to a secrete telephone directory which cannot be viewed without entering a password, the light reflective panel 12 is set to the mirror state.

(5) During Conversation

<1>The light reflective panel 12 is set to the mirror state the instant when the backlight of the display 10 is turned off.

<2>In case key operation to check the call origination/termination history and memo is done, the light reflective panel 12 is set to the transmittance state.

(6) During Web Browsing or Packet Communications

The light reflective panel 12 is permanently set to the transmittance state.

(7) During/After Termination of a Mail

<1>The light reflective panel 12 is set to the transmittance state on termination of a mail.

<2>When the cell phone shifts from the closed state to the open state after termination of a mail, the light reflective panel 12 is set to the transmittance state.

(8) During/After Termination of Various Services (Services to Deliver Contents Including Various Information, Images and Music)

<1>The light reflective panel 12 is set to the transmittance state on termination of various services.

<2>When the cell phone shifts from the closed state to the open state after termination of such services, the light reflective panel 12 is set to the transmittance state.

(9) Manual Operation

When a predetermined key is operated, the light reflective panel 12 is set to the mirror state.

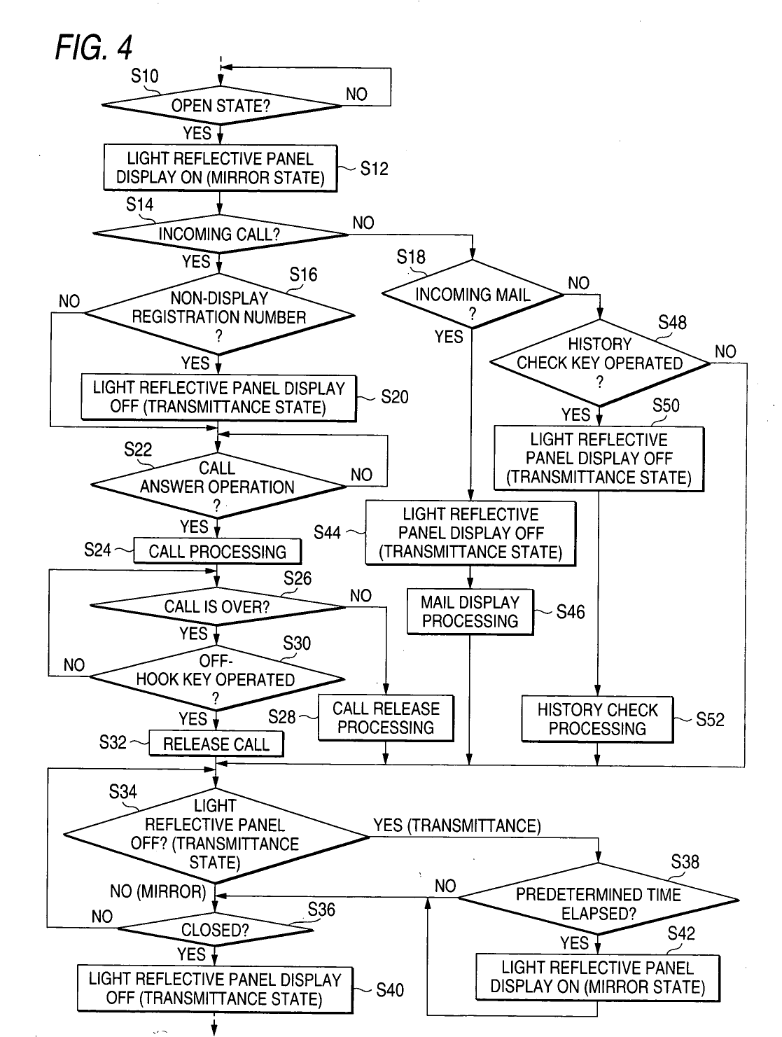

Next, the operation of the cell phone 100 according to this embodiment in communications will be explained referring to the flowchart shown in FIG. 4.

In step S10, the central control 15 determines whether the apparatus main unit is folded or unfolded. In case it is folded, the central control 15 repeats this step. In case it is unfolded, execution proceeds to step S12. In step S12, the central control 15 sets the light reflective panel 12 to the mirror state with display on. That is, the central control 15 issues a command to place the light reflective panel 12 in the mirror state to the control signal generator 13. Receiving this command, the control signal generator 13 applies a predetermined voltage to the light reflective panel 12 to set the light reflective panel 12 to the mirror state.

After setting the light reflective panel 12 to the mirror state, the central control 15 determines presence/absence of call termination in step S14. In case the central control 15 has determined call termination, execution proceeds to step S16. Otherwise execution proceeds to step S18. When execution proceeds to step S16 after determination of presence of call termination, the central control 15 determines whether the calling number is a non-display registration number. In case the calling number is not a non-display registration number, execution proceeds to step S20, where the central control 15 places the light reflective panel 12 in the transmittance state with display off. That is, the central control 15 places the light reflective panel 12 in the transmittance state so that the user of the cell phone 100 may check the calling number. In this case, the central control 15 issues a command to place the light reflective panel 12 in the transmittance state to the control signal generator 13. Receiving this command, the control signal generator 13 discontinues to apply a predetermined voltage to the light reflective panel 12 to set the light reflective panel 12 to the transmittance state.

After setting the light reflective panel 12 to the transmittance state, the central control 15 determines presence/absence of call answer operation in step S22. In case no call answer operation is detected, the central control 15 repeats this step. In case call answer operation is detected, execution proceeds to step S24. In step S24, the central control 15 performs call processing. The central control 15 determines whether the call is over in step S26. In case the cell phone 100 is unfolded or the distant party has cleared the call, execution proceeds to step S28, where the central control 15 carries out the call release processing. In case the distant party has not gone off-hook, execution proceeds to step S30, where the central control 15 determines whether the clear processing has been made through an off-hook key on the cell phone 100. In case the off-hook key is not operated, execution returns to step S26.

When step S28 or step S32 is complete, execution proceeds to step S34, where the central control 15 determines whether the light reflective panel 12 is in the transmittance state. In case the light reflective panel 12 is not in the transmittance state, that is, in the mirror state, execution proceeds to step S36. Otherwise, execution proceeds to step S38.

In case the light reflective panel is in the mirror state, the central control 15 determines whether the cell phone 100 is closed or folded. In case the cell phone 100 is not folded, execution returns to step S34. Otherwise, execution proceeds to step S40. In step S40, the central control 15 sets the light reflective panel 12 to the transmittance state and exits the procedure.

When execution proceeds from step S34 to step S28 after the central control 15 has determined that the light reflective panel 12 is in the transmittance state, the central control 15 determines whether a predetermined time has elapsed. That is, the central control 15 determines whether the time elapsed from the time any of the steps S28, S32, S46 (described later) and S52 (described later) is complete has reached a predetermined time. In case the predetermined time has not elapsed, execution proceeds to step S36. In case the predetermined time has elapsed, execution proceeds to step S42. In step S42, the central control 15 sets the light reflective panel 12 to the mirror state, then execution proceeds to step S36.

When the central control 15 determines absence of call termination in step S14, the central control 15 determines presence/absence of termination of a mail. In case the central control 15 determines presence of termination of a mail, the central control 15 sets the light reflective panel 12 to the transmittance state in step S44, then displays the mail in step S46. After that, execution proceeds to step S34. In case an incoming mail is absent, execution proceeds to step S48, where the central control 15 determines whether the history check key is operated. In case the history check key is not operated, execution proceeds to step S34. In case the history check key is operated, execution proceeds to step S50, where the central control 15 sets the light reflective panel 12 to the transmittance state then checks the history in step S52. When the history check is complete, execution proceeds to step S34.

In this way, according to this embodiment, the light reflective panel 12 whose reflectivity varies with a voltage applied is provided on the LCD 30 of the display. When the cell phone 100 does not perform a predetermined function or operation using the display 10 such as call termination processing, the reflectivity of the light reflective panel 12 is increased, with the panel set to the mirror state and used as a mirror. When the cell phone 100 performs a predetermined function or operation accompanied by display operation, the reflectivity of the light reflective panel 12 is decreased, with the panel set to the transmittance state to make available the LCD 30. By using the light reflective panel 12 whose reflectivity varies in order to provide the function of a mirror, it is possible to recognize the display on the LCD 30 via an external light while the light reflective panel is in the transmittance mode, without turning on the backlight.

The backlight is less often used compared with the case where a half mirror is used. While the light reflective panel is set to the mirror state, the LCD 30 and the backlight can be turned off. This reduces the power current consumption and increases the service life of the rechargeable or dry battery. In this case, the power consumption required to drive the light reflective panel can be made sufficiently smaller than that required for the LCD or backlight. Thus, it is possible to reduce power consumption while providing a cell phone with a function as a mirror.

While a predetermined function or operation as a mirror is under way, the light reflective panel can be set to the mirror mode to provide a mirror on demand. For example, in the case of a call termination from a non-display registration number in the secret telephone directory, it is possible to entirely hide the calling number by placing the light reflective panel in the mirror state. By setting the light reflective panel to the mirror mode in alarm operation, it is possible to check the user's own face at a predetermined time such as the wake-up time. For a collapsible cell phone, providing a light reflective device on the display located inside with the cell phone folded and setting the light reflective device to the mirror state in association with opening/closing of a combination of enclosures makes an electronic apparatus available as a portable mirror.

While the voltage applied to the light reflective panel 12 is controlled by the voltage value set to the reflectivity of the external light which is generally reflected and the voltage value set to the reflectivity of the external light which is generally transmitted in this embodiment, applied voltage adjusting means (not shown) to adjust the value of a voltage applied to the light reflective panel 12 may be provided to apply the voltage of the value adjusted by the applied voltage adjusting means to the light reflective panel 12.

In this case, the light reflective panel 12 provides a faint display of the LCD 30 when the backlight of the display 10 is turned on with the light reflective panel placed in the mirror state. Thus, by providing illumination adjusting means (not shown) for adjusting the illumination of the backlight of the LCS 30 may be provided as well to adjust as required the reflectivity of the light reflective panel 12 and the emission amount of the backlight of the LCD 30. This makes it possible to check the display on the LCD 30 even in case the light reflective panel 12 is set to the mirror state.

While the light reflective panel 12 is provided on the LCD 30 of the LCD 30 in the embodiment, the light reflective panel 12 may be provided on another external surface component section of the cell phone, or on part of whole of the case. FIGS. 5 through 8 show the variations of this embodiment. These variations are examples where the light reflective panel 12 is provided in a location other than the display visible from an external location such as the external surface of the enclosure of the cell phone thus using the light reflective panel as a mirror.

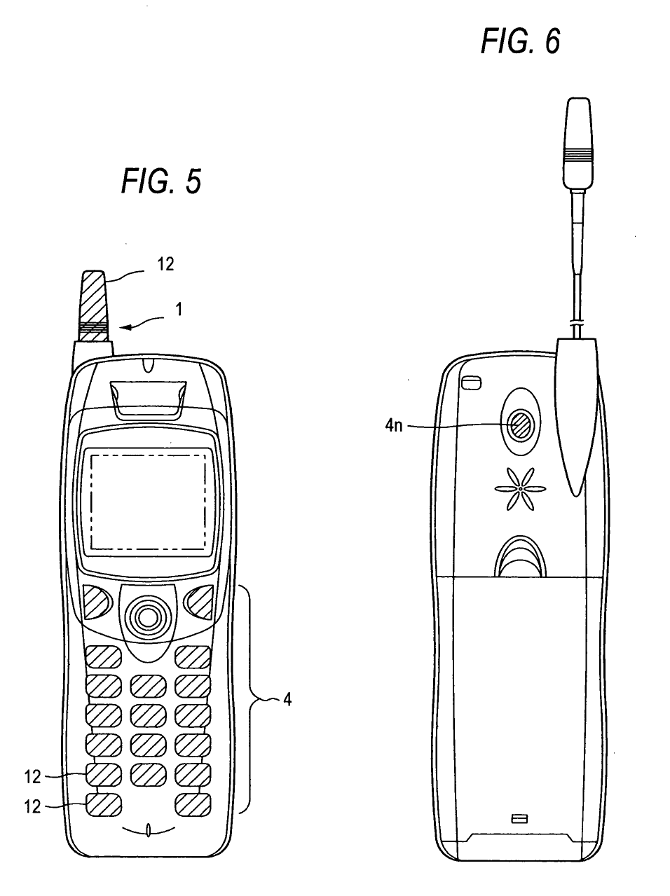

FIGS. 5 and 6 show examples where a light reflective panel 12 is attached to a rod-type cell phone In the example of FIG. 5, the light reflective panel is provided on each key of the key operation section 4 or a tip of the antenna 1. In the example of FIG. 6, the light reflective panel 12 is provided on the key 4n arranged on the rear surface of the case used for checking a memo.

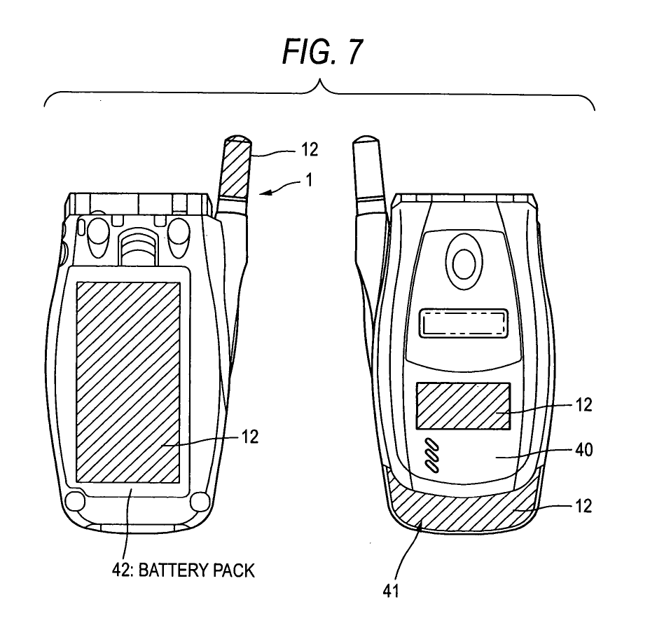

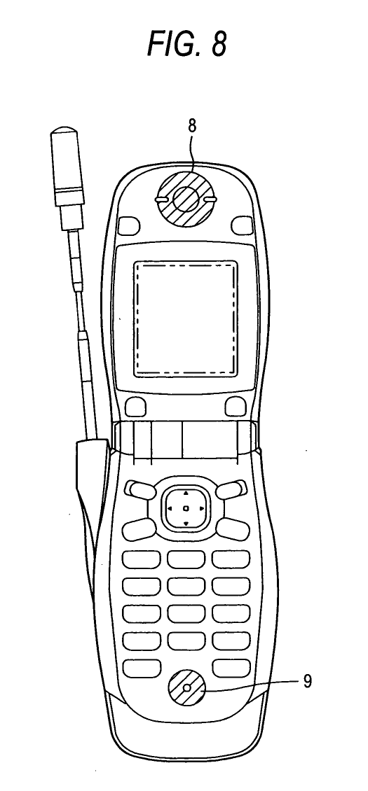

FIGS. 7 and 8 show examples where a light reflective panel 12 is attached to a collapsible cell phone. In the example of FIG. 7, the light reflective panel 12 is provided on an external surface 40 of the case, a mark/logo inscription section 41, a battery pack section 42, or a tip of the antenna 1. In the example of FIG. 8, the light reflective panel 12 is provided on the receiver 8 or microphone 9.

The light reflective panel thus provided may be set to the transmittance or mirror state depending on an arbitrary event including various key operations, opening/closing of the enclosures, antenna extending/housing, display on an LCD, lighting of a light-emitting diode, variation in various operation modes, state change of apparatus, and a predetermined operation.

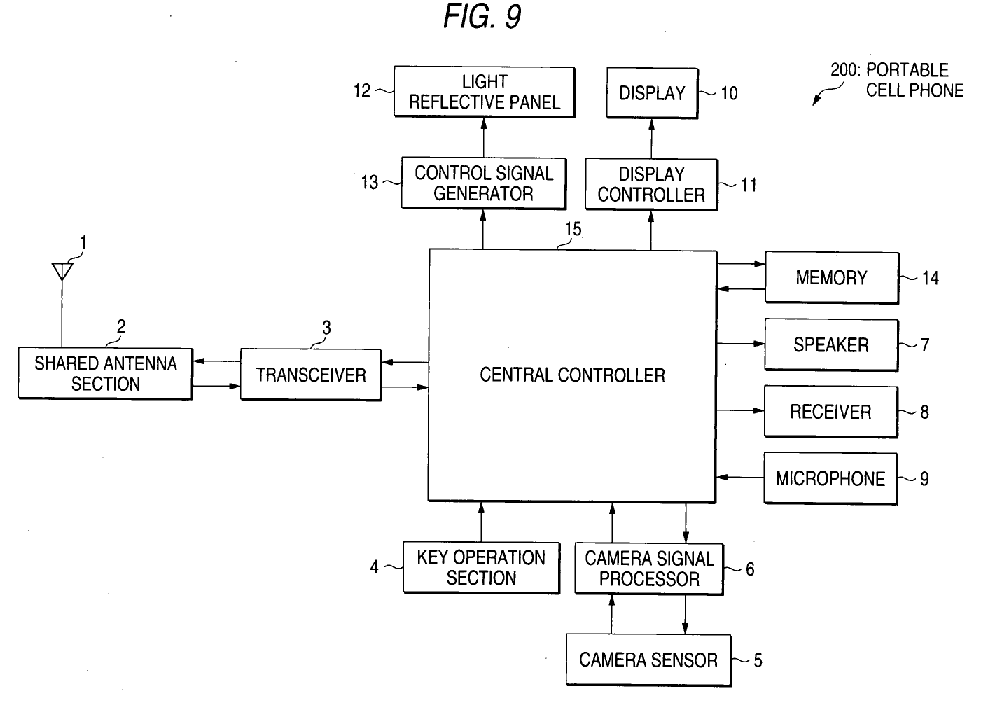

By providing the light reflective panel 12 on an arbitrary section of the cell phone, it is possible to switch the light reflective panel to the mirror state or change the design of the apparatus. For example, it is possible to form the enclosure with a transparent member to switch the light reflective panel between the approximately transparent skeleton state and the mirror state just like a mirror. It is possible to paint the interior of the enclosure formed with the transparent member to switch between an arbitrary color and a mirror color, or paint the interior and exterior of the enclosure with different colors to give different transmittances depending on the light reflective panel used. Thus it is possible to allow a desired location to serve as a mirror in an arbitrary operating state or change the color design of the part or whole of the enclosure without changing the shape or arrangement of the enclosure. This differentiates the product with functions and design. The user can enjoy a plurality of designs and readily check the operating state of the apparatus.

[Second Embodiment]FIG. 9 is a block diagram showing the configuration of a cell phone according to the second embodiment of the invention. In FIG. 9, sections common to those in FIG. 1 are given the same signs/numerals and the corresponding description is omitted.

A cell phone 200 according to this embodiment comprises a camera sensor 5 and a camera signal processor 6 on top of the similar configuration of the cell phone 100 according to the first embodiment. The camera sensor 5 comprises an image pickup device such as a CCD (Charge-coupled Device) which is not shown and a CMOS optical sensor, and converts the image of a subject shot to an image signal through photoelectric conversion and outputs the resulting image signal. The camera signal processor 6 converts an image signal from the camera sensor 5 to a signal format which may undergo input/output or signal processing by the central control 15 as well as controls the camera sensor 5 in accordance with a command from the central control 15.

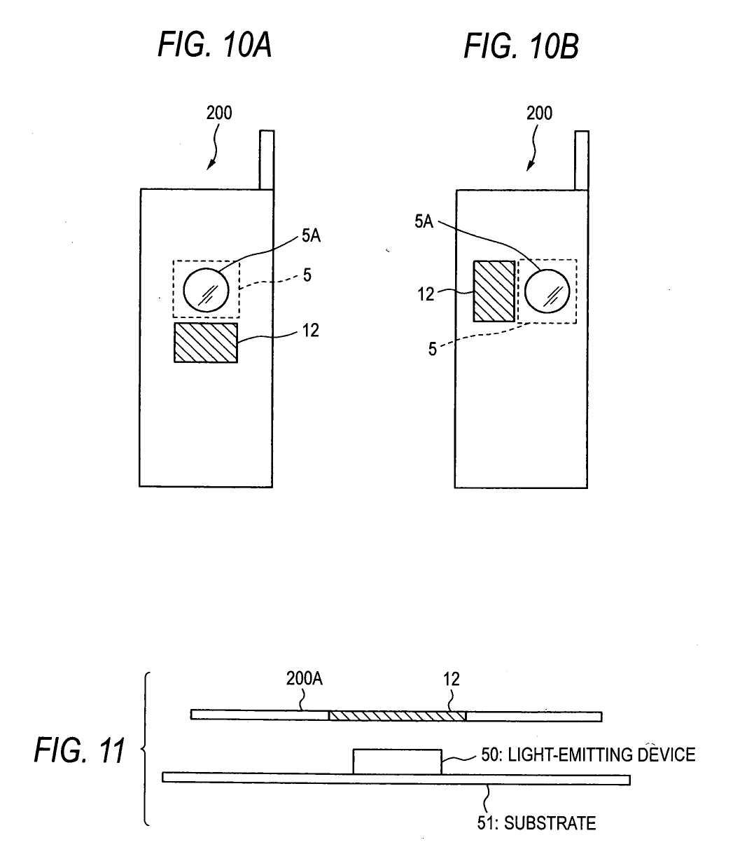

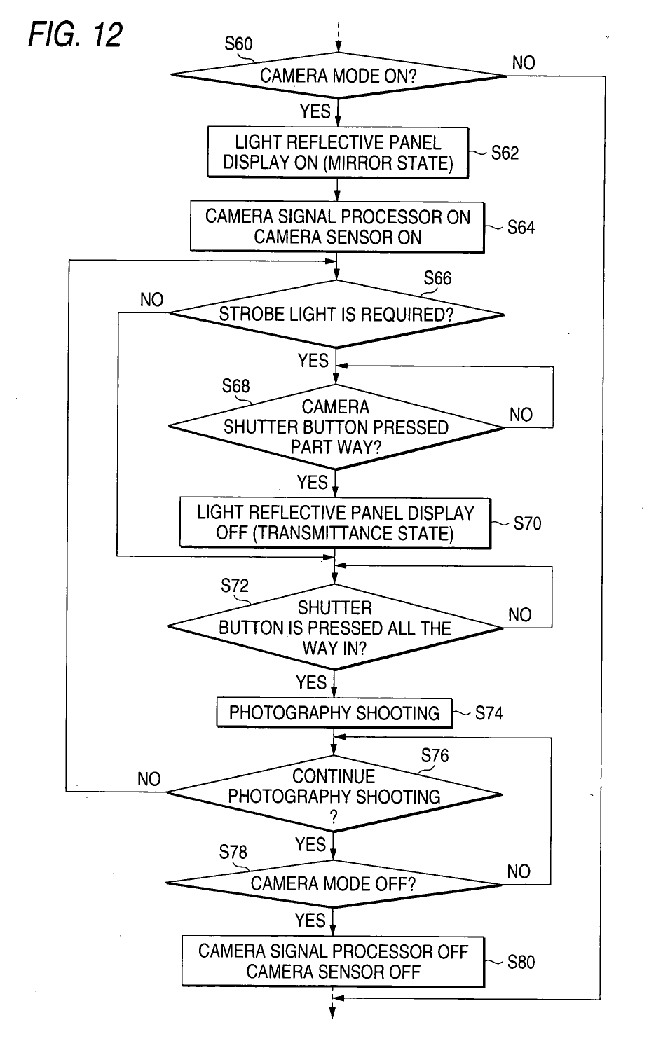

FIGS. 10A and 10B show exemplary locations of the cell phone 200 where the light reflective panel 12 and the camera sensor 5 are attached. FIG. 10A shows an example where the light reflective panel 12 and the camera sensor 5 are arranged side by side along the enclosure of the cell phone 200. FIG. 10B shows an example where the light reflective panel 12 and the camera sensor 5 are arranged side by side across the enclosure of the cell phone 200. The camera sensor is provided with a lens 5A for photography shooting externally exposed. The light reflective panel 12 is attached so as to engage in a window made in part of the enclosure 200A of the cell phone 200, as shown in FIG. 11. In the cell phone 200, a light-emitting device 50 such as a Light-emitting Diode (LED) is mounted on a substrate 51. The light-emitting device 50 is used as a strobe light for auxiliary illumination of a camera and used to notice call termination when the camera function is not in use.

The central control 15 sets the light reflective panel 12 to the transmittance state to cause a light from the light-emitting device 50 to be externally irradiated when the shutter button is pressed part way while the camera function is being used. In this case, the light-emitting device 50 is illuminated the instant when the light reflective panel 12 is placed in the transmittance state. When an incoming call is detected while the camera function is not in use, the light reflective panel 12 is set to the transmittance state and the light-emitting device 50 is caused to blink no notify the user of the incoming call.

The following lists the cases where the central control 15 sets the light reflective panel 12 to the mirror state or transmittance state:

(1) Camera Operation

<1>When the camera menu is selected, the light reflective panel 12 is set to the mirror state.

<2>On termination of a call, mail or various services in the mirror state, the light reflective panel 12 is set to the transmittance state even in case the camera menu is selected, and the light-emitting device 50 illuminates or blinks.

<3>When a strobe light is used, the light reflective panel 12 is set to the transmittance state immediately before the camera shutter is released and the light-emitting device 50 illuminates to irradiate a light onto the subject like in use of a strobe light. An image pickup device such as a CCD or CMOS can obtain the sufficient amount of light exposure through the light quantity of a light-emitting diode.

(2) During Call Origination

The light reflective panel 12 is set to the transmittance state.

(3) During Call Termination

The light emitting device 50 is made to illuminate or blink while the light reflective panel 12 is set to the transmittance state.

(4) During Conversation, Web Browsing or Packet Communications

The light emitting device 50 is made to illuminate or blink while the light reflective panel 12 is set to the transmittance state.

(5) During/After Termination of a Mail

The light emitting device 50 is made to illuminate or blink while the light reflective panel 12 is set to the transmittance state.

(6) During/After Termination of Various Services (Services to Deliver Contents Including Various Information, Images and Music)

The light emitting device 50 is made to illuminate or blink while the light reflective panel 12 is set to the transmittance state.

Next, the operation of the cell phone 200 according to this embodiment in communications will be explained referring to the flowchart shown in FIG. 4.

In step S60, the central control 15 determines whether the camera mode (shooting mode) is on. In case the camera mode is not on, the central control 15 exits the procedure. In case the camera mode is on, execution proceeds to step S62, where the central control 15 turns on the display of the light reflective panel 12 to set the light reflective panel 12 to the mirror state. In step S64, the central control 15 turns on the camera signal processor 6 and the camera sensor 5 respectively.

In step S66, the central control 15 determines whether a strobe light is required, based on the output of an image pickup device or optical sensor (not shown). In case a strobe light is required, execution proceeds to step S68. Otherwise execution proceeds to step S72. In case a strobe light is required, the central control 15 determines whether the shutter button is pressed part way such as in a focus lock state in step S68. In case the shutter button is not pressed part way, execution repeats this step. In case the shutter button is pressed part way, execution proceeds to step S70, where the central control 15 turns off the display of the light reflective panel 12 and sets the light reflective panel 12 to the transmittance state as well as causes the light-emitting device 50 to illuminate.

Next, in step S72, the central control 15 determines whether the shutter button is pressed all the way in. In case the shutter button is not pressed all the way in, execution proceeds to step S74, where the central control 15 performs photography shooting. That is, the central control 15 fetches image data output from the camera signal processing 6 and writes the data acquired into the RAM of the memory 14.

When photography shooting is complete, the central control 15 determines whether photography shooting is to be continued based on the presence/absence of key operation for photography shooting. In case photography shooting is to be continued, execution returns to step S66. Otherwise execution proceeds to step S78, where the central control 15 determines whether the camera mode is off. In case the camera mode is not off, execution returns to S76, where the central control 15 determines that photography shooting is to be continued. In case the camera mode is off, the central control 15 turns off the camera signal processor 6 and the camera sensor 5 respectively and exits the procedure.

In case call termination is noticed in this embodiment, the light reflective panel 12 is set to the transmittance state and the light-emitting device 50 is made to blink on call termination. In case off-hook key operation is performed of the caller has abandoned the call while the called party is being rung, the central control 15 stops blinking of the light-emitting device 50 and sets the light reflective panel 12 to the mirror state.

In this way, in this embodiment, the light reflective panel 12 provided in close proximity of the camera sensor 5 is set to the mirror state when the camera mode is entered. The light reflective panel 12 is set to the transmittance state in case a strobe light is required for photography shooting or when call termination is noticed. Thus, it is possible to use the light reflective panel 12 as a mirror to determine the composition to accommodate the user in the shooting area. The light reflective panel 12 can be set to the transmittance state in case the light from the light-emitting device 50 is required. As a result, the light reflective panel 12 can be shared by the mirror function and the shutter for the light-emitting device.

The cell phone according to the invention can be also used as a mirror. Light-emitting means used as a strobe light for a camera and call termination notice means can be arranged inside the light reflective panel, which reduces the number of parts thus attaining space saving.

While a cell phone is used as an example of an electronic apparatus, a portable terminal such as a PHS (registered trademark) PDA, and a pager may be used instead. Moreover, the invention is applicable to digital audio players such as a portable MD (Mini Disk) player, CD player, and MP3, cassette player and a radio. Further, the invention may be applied to household electrical appliances such as a refrigerator and a microwave oven, on which a display or a light reflective panel may be provided. For an electronic apparatus having a touch panel for operation/input provided on the operation section or display of the enclosure, the touch panel section may be provided with a light reflective panel.

While the invention has been described in detail referring to specific embodiment, those skilled in the art will recognize that various changes and modifications can be made in it without departing from the spirit and scope thereof.

This patent application is based on the Japanese Patent Application filed Jun. 15, 2001 (the Japanese Patent Application No. 2001-181813), the disclosure of which is incorporated herein by reference.

### INDUSTRIAL APPLICABILITY

As mentioned hereinabove, the invention provides a light reflective device whose reflectivity varies with a voltage applied and the value of a voltage applied to the light reflective device is changed in association with an operation or a function of the electronic apparatus. This has an advantage of providing an electronic apparatus equipped with a mirror which can function in an arbitrary operating state.

It is thus possible to provide an electronic apparatus which attains low power consumption while serving as a mirror.

It is also possible to provide an electronic apparatus which allows a desired location to serve as a mirror or which can switch a desired location to a mirror to change the apparatus design.

1. An electronic apparatus comprises:
a light reflective device provided on the whole or part of a section visible from outside the apparatus, wherein a reflectivity of said light reflective device varies with a voltage applied; and
a controller for controlling the value of a voltage applied to said light reflective device in association with an operation or a function of the apparatus.

2. The electronic apparatus according to claim 1,
wherein, when a voltage is not applied, said light reflective device enters a light transmittance state where a light is generally transmitted, and when a predetermined voltage is applied, said light reflective device enters a mirror state where a light is generally reflected.

3. The electronic apparatus according to claim 1 or 2,
wherein said controller controls the voltage applied to said light reflective device and sets said light reflective device to a mirror state where a light is generally reflected in a predetermined state in association with an operation or a function of the apparatus.

4. The electronic apparatus according to claim 1 or 2,
wherein said controller controls the voltage applied to said light reflective device and sets said light reflective device to a transmittance state where a light is generally transmitted in a predetermined state in association with an operation or a function of the apparatus.

5. The electronic apparatus according to claim 1 or 2, further comprising:
a display for providing display concerning an operation or a function of the apparatus;
wherein said light reflective device is formed into the shape of a plate or a film and is provided on said display means.

6. The electronic apparatus according to claim 5,
wherein said display includes an LCD, and
wherein said controller sets said light reflective device to the mirror state where a light is generally reflected in a predetermined state in association with an operation or a function of the apparatus and turns off said LCD concurrently.

7. The electronic apparatus according to claim 1 or 2, further comprising:
image pickup means for shooting a subject;
wherein said light reflective device is formed into the shape of a plate or a film and is provided in close proximity of said display means.

8. The electronic apparatus according to claim 7, further comprising:
a light-emitting device provided inside said light reflective device;
wherein said controller sets said light reflective device to the mirror state where a light is generally reflected in a shooting mode by using said image pickup means, and sets the light reflective device to the transmittance state where a light is generally transmitted when said light-emitting device is illuminated.

9. The electronic apparatus according to claim 1 or 2,
wherein said light reflective device is formed into the shape of a plate or a film and is provided on at least part of an enclosure or external surface component of the apparatus.
